(19) United States
(12) Patent Application Publication
(10) Pub. No.: US 2003/0065956 A1
(43) Pub. Date: Apr. 3, 2003

(54) Challenge-response data communication protocol

(76) Inventors: Abhijit Belapurkar, Jersey City, NJ (US); Gayathri Krishnamurthy, Jersey City, NJ (US); Abdul Rafman Azeez, Watchung, NJ (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/967,774

(22) Filed: Sep. 28, 2001

(51) Int. Cl. H04L 9/00

(52) U.S. Cl. 713/202; 713/150

(57) ABSTRACT

A data communication technique facilitates the transmission of a data element in a trusted manner such that the receiver component can trust that the data element was not modified during the transmission. In addition, the receiver component is assured that the data element could only have been transmitted by a particular sender component. The data communication technique utilizes a challenge-response routine that ensures data integrity and non-repudiation. The data element is sent from the sender component to the receiver component during the challenge-response routine; in accordance with the example embodiment, the hashed response generated by the sender component is based upon the data element. The data communication technique can be implemented in the context of a single sign-on protocol that allows an authenticated user of a linking site to access protected resources associated with a linked web site without having to separately login to the linked web site.

### FIELD OF THE INVENTION

The present invention relates generally to data communication systems. More particularly, the present invention relates to a protocol for communicating data in a trustworthy manner between two components such that data integrity is ensured.

### BACKGROUND OF THE INVENTION

Countless systems rely on the communication of data between two processing components. For example, computer networks facilitate the exchange of files, programs, and data between individual computers. As another example, the Internet facilitates communication between any number of individual personal computers (PCs) and any number of web sites maintained on server computers. Certain situations call for the trusted exchange of data from one component to another, e.g., the transmission of user login data or the transmission of confidential files. In this regard, the receiving component must be certain that the data was not modified while being transmitted from the sending component (i.e., the integrity of the transmitted data element must be preserved). In addition, the receiving component must be certain that the received data could have been sent only by the actual sending component (i.e., non-repudiation of the data must be guaranteed). Known techniques for ensuring data integrity and non-repudiation may be inadequate, require excessive amounts of processing overhead, and/or require extensive infrastructure.

During the course of a transaction or query, a user often needs to access information or resources that lie across different technology domains (i.e., systems protected by different security mechanisms that are independently managed). The different technology domains may lie in separate organizations or may be independently administered domains within the same organization. For example, Internet web sites may restrict access to authorized users by mandating a login or authentication procedure. Typically, a user is prompted to enter his username and password to access to a restricted web site (or to access restricted features of a web site). A web site may provide a link to access another restricted web site or to access any restricted web resource. In some situations, the user will be required to enter another username and password to access the linked resource. In this regard, navigating between a number of restricted sites can be time consuming and frustrating.

Known solutions to the multiple authentication problem may be referred to as “single sign-on” techniques. In accordance with one known technique, a third party resource maintains a list of usernames and corresponding passwords for each desired resource. Thus, after the user is authenticated, the third party resource can manage access to other restricted resources. Unfortunately, many users and organizations are hesitant to disclose confidential usernames and passwords to a third party (particularly when there exists a risk of unauthorized access to such information). Alternatively, each of the linked web sites can agree to merge security mechanisms, which results in a loss of autonomy and control by the individual sites. In reality, established organizations may be reluctant to change existing and proven security measures for the convenience of affiliated organizations.

In view of the shortcomings of conventional single sign-on approaches, there exists a need for a technique that facilitates the seamless passing of security credentials between different security control mechanisms, thus allowing a user to easily navigate between a number of restricted resources.

### BRIEF SUMMARY OF THE INVENTION

A data communication protocol according to the present invention facilitates the transmission of a data element from a sender component to a receiver component in a manner that enables the receiver component to verify the integrity of the received data element. In addition, the protocol can be performed such that non-repudiation of the data element (by the sender component) can be guaranteed. In practice, the protocol can be utilized to provide a single sign-on feature in connection with a number of affiliated web sites. In such an application, the existing security measures used by the individual web sites need not be modified.

The above and other aspects of the present invention may be carried out in one form by a data communication method that conducts a challenge-response protocol to establish trust between a first component and a second component, sends a data element from the first component to the second component during the challenge-response protocol, and verifies the integrity of the data element as received by the second component.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic block diagram of a data communication system;

FIG. 2 is a schematic block diagram of a sender component;

FIG. 3 is a schematic block diagram of a receiver component;

FIG. 4 is a flow diagram representing a data communication protocol; and

FIG. 5 is a flow diagram representing a single sign-on protocol.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, processing elements, firmware elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional techniques related to HTTP, encryption, data transmission, signaling, web servers, web browsers, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

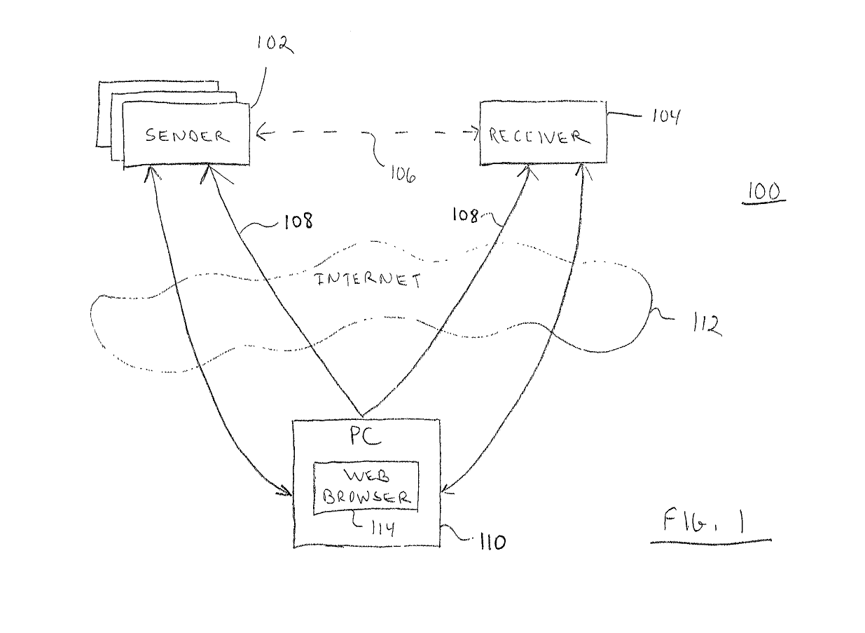

FIG. 1 is a schematic block diagram of a data communication system 100 including a sender component 102 and a receiver component 104. Sender component 102 and receiver component 104 are capable of communicating with each other via, e.g., a direct connection 106 (represented by the dashed line) or an indirect connection (represented by the redirected path 108). Generally, sender component 102 and receiver component 104 may each be realized as one or more hardware devices, one or more firmware elements, one or more software applications, or any combination thereof. For example, sender component 102 and receiver component 104 may each be realized in a personal computer (PC), a personal digital assistant (PDA), a wireless telephone, or a server computer. In one practical embodiment, sender component 102 and receiver component 104 are each associated with a different web site (the components may be realized in the server computers that maintain the web sites).

In a practical Internet embodiment where sender component 102 and receiver component 104 correspond to different web sites, a user PC 110 is capable of communicating with sender component 102 and receiver component 104 via a network 112 (such as the Internet). As represented by path 108, PC 110 is capable of redirecting HTTP traffic from sender component 102 to receiver component 104, and vice versa. In this regard, sender component 102 need not directly communicate with receiver component 104. PC 110 may include a suitable web browser application 114 that allows the user to navigate web sites, redirects traffic between web sites, and otherwise functions in a conventional manner.

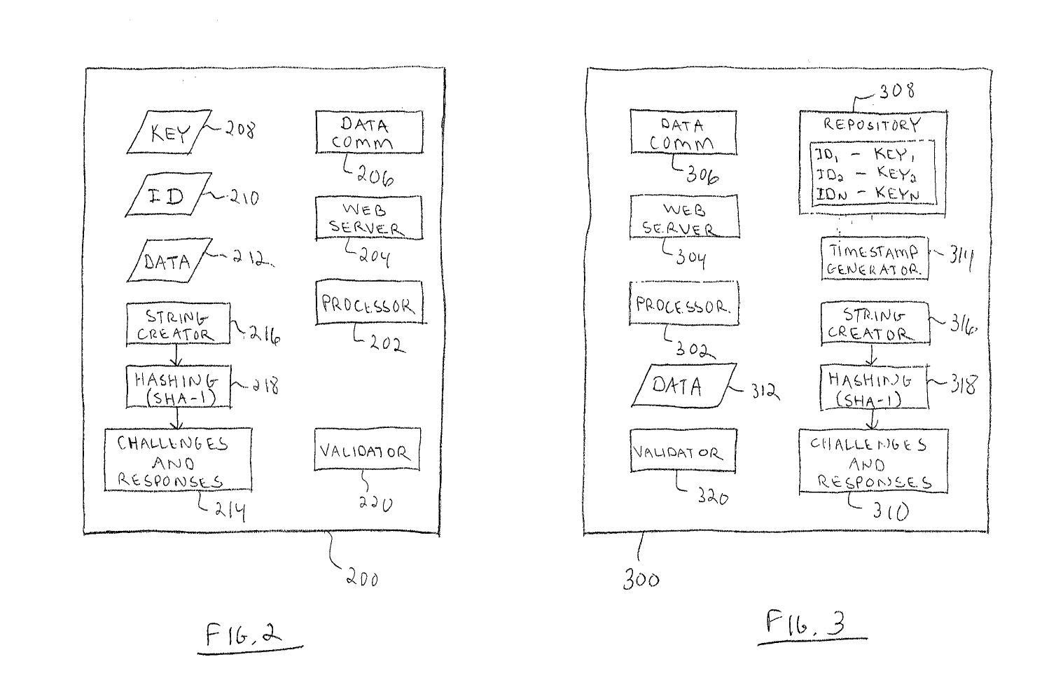

FIG. 2 is a schematic block diagram of an example sender component 200, which may be suitable for use in data communication system 100. FIG. 2 illustrates certain data elements and functional features of sender component 200 to aid in the following description of the data communication protocol. Data elements may be stored in and retrieved from any suitable memory element such as a magnetic disk, a ROM, or the like. Functional elements shown in FIG. 2 may be realized in any number of computer program instructions, in firmware, in hardware, or in any combination thereof.

Sender component 200 generally includes a processor 202, a web server 204, and a data communication element 206. Processor 202 is suitably configured to carry out the techniques, protocols, and software instructions described herein. Web server 204 may be configured in accordance with conventional techniques to enable sender component 200 to deliver web pages to web browsers and/or to other web servers. Data communication element 206, which may include hardware, firmware, and/or software, facilitates the exchange of data, signals, packets, and information between sender component 200 and other components, e.g., the receiver component or the user's PC.

As described in more detail below, sender component 200 may generate, store, retrieve, process, or send the following (and possibly other) items in connection with the data communication protocol: a shared secret key 208, an identifier 210, one or more data elements 212, and any number of challenges and responses 214. Sender component 200 may also include a string creator 216 configured to form various strings utilized by sender component 200, a hashing element 218 configured to perform hashing operations on data, and a validator 220 configured to perform a validation routine on challenges and/or responses processed by sender component 200. String creator 216, hashing element 218, and validator 220 may each be implemented in software, hardware, firmware, or a combination thereof, and each can be executed or controlled by processor 202 or by any suitable processing element associated with sender component 200. The relevance of these items and features, their characteristics, and the manner in which sender component 200 interacts with the receiver component are discussed below.

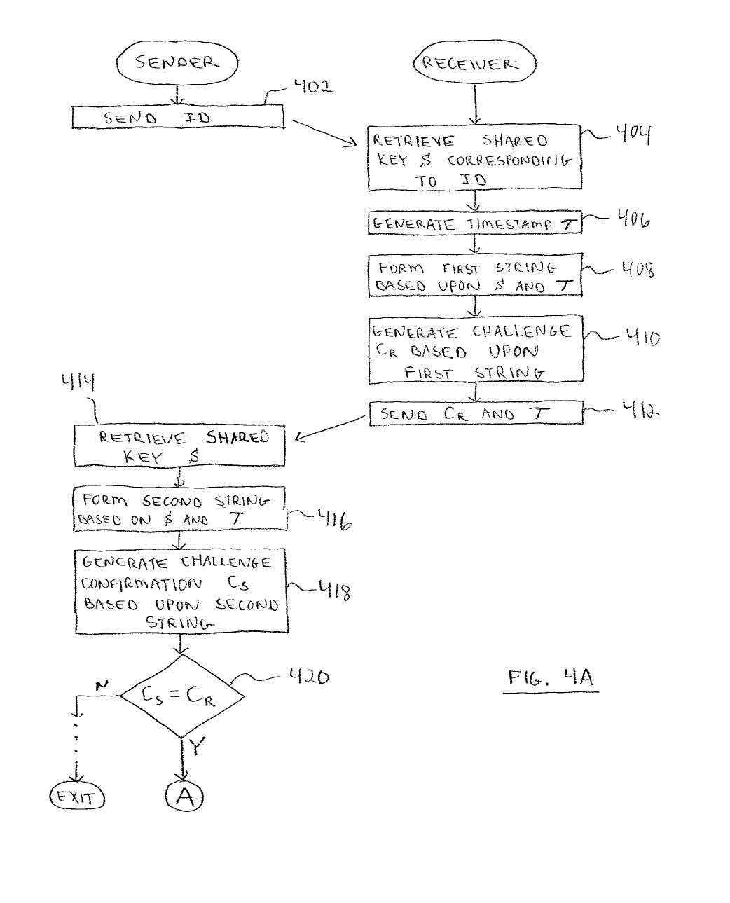

FIG. 3 is a schematic block diagram of an example receiver component 300, which may be suitable for use in data communication system 100. As in FIG. 2, the data elements shown in FIG. 3 may be stored in and retrieved from any suitable memory element such as a magnetic disk, a ROM, or the like. In addition, the functional elements shown in FIG. 3 may be realized in any number of computer program instructions, in firmware, in hardware, or in any combination thereof.

Receiver component 300 generally includes a processor 302, a web server 304, and a data communication element 306. These elements are similar to the corresponding elements described above in connection with FIG. 2. Data communication element 306, which may include hardware and/or software, facilitates the exchange of data, signals, packets, and information between receiver component 300 and other components, e.g., sender component 200 or the user's PC.

Receiver component 300 may include a repository 308 (e.g., a look-up table) containing a number of entries, where each entry includes an identifier and a corresponding shared secret key. Repository 308 may be stored in a suitable memory or storage element associated with receiver component 300. In one practical embodiment, repository 308 is created prior to the data communication session between the sender component and the receiver component. Repository 308 may be updated from time to time to reflect the addition or removal of entries. Receiver component 300 may also generate, store, retrieve, process, or send other items in connection with the data communication protocol, such as any number of challenges and responses 310, and any number of data elements 312 received from one or more sender components. Receiver component 300 may also include a timestamp generator 314 configured to create a timestamp, a string creator 316 configured to form various strings utilized by receiver component 300, a hashing element 318 configured to perform hashing operations on data, and a validator 320 configured to perform a validation routine on challenges and/or responses processed by receiver component 300. Timestamp generator 314, string creator 316, hashing element 318, and validator 320 may each be implemented in software, hardware, firmware, or a combination thereof, and each can be executed or controlled by processor 302 or by any suitable processing element associated with receiver component 300. The relevance of these items and features, their characteristics, and the manner in which receiver component 300 interacts with sender component 200 are discussed below.

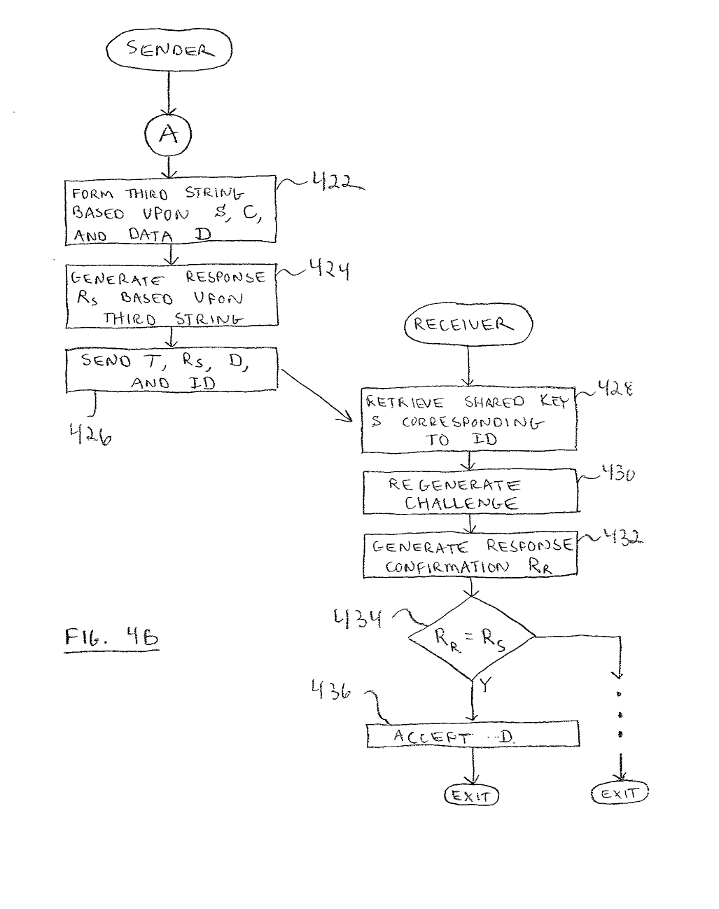

FIG. 4 is a flow diagram representing a data communication protocol according to the present invention. FIG. 4 represents a generalized protocol that can be performed by any sender component and any receiver component configured to communicate with one another, regardless of the manner in which such components are actually implemented. For example, as shown in FIG. 1, the two components can communicate directly or indirectly with each other. The protocol can be utilized in conjunction with any data communication technology, e.g., HTTP. The particular type of communication technology can range from relatively high-level (such as the Java Messaging Service) to relatively low-level (such as the opening of raw sockets). For purposes of illustration and consistency, the protocol will be described with additional reference to FIG. 2 and FIG. 3.

Generally, a challenge-response protocol is conducted to establish trust between the sender component 200 and the receiver component 300. In the example embodiment, the receiver component 200 issues the challenge and the sender component 300 responds to the challenge. During the challenge-response protocol, the sender component 200 sends a data element 212 to the receiver component 300. In the preferred practical embodiment, the data element 212 is sent along with a suitably configured response. Finally, the receiver component 300 verifies the integrity of the received data element 212 to ensure that the data element 212 was not modified during the transmission.

For purposes of this example, the sender component 200 and the receiver component 300 have prior knowledge of a shared secret key 208, which may be encrypted or otherwise stored in a secure manner. In a practical embodiment, the shared secret key 208 is unique to the sender-receiver combination and one receiver component may be configured to communicate with a plurality of different sender components (each having a different secret key shared with the receiver component). In addition, the example process assumes that the sender component 200 intends to send a specific data element 212 to the receiver component 300.

The data communication technique begins when the sender component 200 sends an identifier (ID) 210 to the receiver component 300 (task 402). The ID 210 can be an alphanumeric string or any suitably configured parameter that identifies the sender component 200 to the receiver component 300. The receiver component 300 receives the ID 210 and retrieves a secret key (s) corresponding to the ID 210 (task 404). The secret key is shared between the sender component 200 and the receiver component 300. As described above in connection with FIG. 3, the receiver component may interrogate its key repository 308 to determine which key corresponds to the received ID 210. The key 208 can be an alphanumeric string or any suitably configured parameter. In lieu of secret keys, the sender and receiver components can employ digital certificate and/or other techniques to enhance the security of the protocol.

Next, the receiver component 300 creates a timestamp (T) that represents the current time (task 406). The timestamp can be an alphanumeric string or any suitably configured parameter generated by the timestamp generator 314. The timestamp is utilized to thwart “replay” attacks wherein a malicious user manages to obtain a valid response as it travels from the sender component 200 to the receiver component 300. The receiver component 300 can reject a saved and resent response by mandating that a returned timestamp (discussed below) lies within a specified time window, i.e., the difference between the time when the receiver component 300 receives the response and the original timestamp included in the response must be less than a certain value. The receiver component 300 can be configured such that the time difference is very small, thus limiting the window of opportunity for a malicious user.

In the example embodiment, the receiver component 300 employs the string creator 316 to form a first string based upon the secret key and the timestamp (task 408). In view of its dependence upon the secret key, the first string is also based upon the ID 210 received from the sender component 200. In a simple embodiment, the first string is obtained by concatenating the secret key and the timestamp; the first string is represented by the expression (s+T). Alternatively, the receiver component 300 can utilize any suitable algorithm, formula, or relationship to generate the first string.

The receiver component 300 generates a challenge (Cr) based upon the first string (task 410). In other words, the challenge is based upon the secret key and the timestamp. In addition, the challenge is indirectly based upon the sender ID 210. The receiver component 300 is preferably configured to generate a unique challenge corresponding to each unique string. In other words, no two strings will result in the same challenge. In this regard, a practical embodiment performs a suitable hashing operation 218 during task 410. For example, the receiver component 300 may perform a one-way hashing operation on the first string to obtain the challenge. A one-way hashing operation ensures that, knowing only the challenge, it is nearly impossible to derive the first string. A one-way hashing operation also ensures that only one possible input string can lead to the same challenge. In accordance with the currently preferred embodiment, the receiver component 300 employs the SHA-1 hashing operation to generate the challenge:

Cr=SHA-1[s+T].

The SHA-1 hashing algorithm, which is virtually an industry standard, is considered to be one of the strongest hashing algorithms currently available. In accordance with the SHA-1 hashing operation, the challenge (Cr) is configured as a string of 40 alphanumeric characters. Alternate embodiments may utilize different operations or algorithms to generate challenges having different characteristics (preferably maintaining the characteristics of a one-way hashing operation). For example, the MD-5 hashing algorithm can be used instead of the SHA-1 hashing algorithm.

The receiver component 300 sends the challenge and the timestamp to the sender component 200 (task 412). In the example embodiment, the timestamp is sent to enable the sender component 200 to regenerate the challenge. In this regard, the sender component 200 performs a validation routine 220 to ensure that only the receiver component 300 could have sent the challenge (Cr). The sender component 200 retrieves the secret key 208 it shares with the receiver component 300 (task 414), forms a second string based on the secret key and the timestamp received from the receiver component (task 416), and generates a challenge confirmation (Cs) based upon the second string (task 418). Tasks 416 and 418 respectively correspond to tasks 408 and 410 described above. In this respect, the sender component 200 may include a string creator 216 for forming the second string, and a hashing element 218 that generates the challenge confirmation. Notably, the sender component 200 generates the challenge confirmation independently by using a locally stored version of the secret key(s) 208 and the timestamp (T) it receives from the receiver component 300.

In accordance with one practical embodiment, the sender component 200 need not utilize multiple secret keys—any one sender component 200 uses only one secret key. However, in an alternate embodiment, one sender component could interact with multiple receiver components, thus requiring the sender component to maintain a secret key repository that matches keys with specific receiver components. In such an embodiment, the receiver component 300 would have a corresponding receiver ID, which would be sent to the sender component 200 along with the challenge and the timestamp during task 412.

The sender component 200 validates the received challenge by comparing it to the challenge confirmation (query task 420). The sender component 200 may utilize the validation routine 220 for this purpose. If query task 420 determines that Cs=Cr, then a task 422 is performed by the sender component 200 (see the continuation of the flow diagram at FIG. 4B). On the other hand, if Cs≠Cr, then the protocol may exit, take corrective measures, or otherwise handle the error condition in an appropriate manner.

Referring to FIG. 4B, the sender component 200 sends a response to the challenge, along with the desired data element 212, to the receiver component 300 if it validates the challenge. To this end, during task 422 the sender component 200 forms a third string based upon the secret key(s) 208, the challenge (either Cr or Cs), and the data element (D) 212. In the example embodiment, the third string is obtained by concatenating the secret key 208, the data element 212, and the challenge; the third string is represented by the expression (s+D+C). Alternatively, the sender component 200 can utilize any suitable algorithm, formula, or relationship to generate the third string.

The sender component 200 generates a response (Rs) based upon the third string (task 424). In other words, the response can be based upon the secret key 208, the data element 212, and the challenge. In addition, the challenge is indirectly based upon the sender ID 210, which corresponds to the secret key 208. The example embodiment performs a suitable hashing operation 218 during task 424. For example, the sender component 200 may perform a one-way hashing operation on the third string to obtain the response. As described above, the currently preferred embodiment may employ the SHA-1 hashing operation to generate the response:

Rs=SHA-1[s+D+C].

In accordance with the SHA-1 hashing operation, the response (Rs) is configured as a string of 40 alphanumeric characters. Alternate embodiments may utilize different operations or algorithms to generate responses having different characteristics.

After the response has been generated, the sender component 200 sends the timestamp (T) back to the receiver component 300, along with the response, the data element 212, and the sender ID 210 (task 426). The timestamp and the sender ID 210 (the same ID 210 that was initially sent by the sender component during task 402) are sent so that the receiver component 300 need not store or recall the previous occurrences of those variables. Assuming that the communication link has remained intact, the receiver component 300 eventually receives the timestamp, response, data element 212, and ID 210 from the sender component 200. Generally, the receiver component 300 verifies the integrity of the received data element 212 by performing a validation routine 320 on the response. If the receiver component 300 validates the response, then it can accept the data element 212 as trusted information.

More specifically, the receiver component 300 obtains the newly-received ID 210 and again retrieves the shared key (s) corresponding to the ID 210 (task 428). Task 428 is similar to task 404 described above. Next, the receiver component 300 regenerates the challenge (task 430) that it originally sent to the sender component 200. During task 430, the receiver component 300 utilizes the shared key retrieved during task 428 and the timestamp it received from the sender component 200. In this regard, the receiver component 300 need not memorize any previously processed information or strings. In the example embodiment, task 430 regenerates the challenge in the same manner described above in connection with tasks 408 and 410.

The receiver component 300 can then use the newly regenerated challenge to generate a response confirmation (Rr) (task 432). During task 432, the receiver component 300 generates the response confirmation based upon the key retrieved during task 428, the data element 212 received from the sender component, and the regenerated challenge as follows:

Rr=SHA-1[s+D+C].

In this regard, task 432 is similar to task 424 described above. After it generates the response confirmation, the receiver component 300 compares the response confirmation to the response sent by the sender component 200 (query task 434). If query task 434 determines that Rr=Rs, then the receiver component 300 can accept the data element 212 as a trusted piece of information (task 436). Thus, the data communication protocol has established trust between the receiver component 300 and the sender component 200 and the receiver component 300 can assume that the integrity of the data element 212 has remained intact (i.e., the data was not modified in transit from the sender component) and that the data element 212 could not have been sent by any other components. However, if query task 434 determines that Rr≠Rs, then the protocol may exit, take corrective measures, or otherwise handle the error condition in an appropriate manner.

The generalized trust establishment protocol described above can be utilized in any number of practical data communication environments to address a variety of issues. In accordance with one practical application, the protocol is implemented in a product designed to act as a credential bridge between different access control mechanisms. One objective of the product is to integrate the functioning set of web site access control mechanisms so that the PC user (having access to the web sites via a web browser application) can login at a single point rather than at multiple points corresponding to multiple sites. In contrast to existing techniques, the product need not attempt to manage the entire set of security issues corresponding to a plurality of web site control and access mechanisms. In this regard, the product permits different access control regimes to become invisible to the PC user without the loss of autonomy that would otherwise result from the installation of a standard single sign-on application.

In one example scenario, a company may maintain a protected portal web site designed for integration with business partner web sites. The portal site can be designed such that customers of the business partner can access authorized portions of the portal site without having to explicitly login to the portal site. Further, the company may want to integrate third party service providers with its web portal without forcing its customers to login to the service providers' sites. In this scenario, the techniques of the present invention can be utilized to seamlessly exchange security credentials across the different security control domains utilized by the portal site, the business partner sites, and/or the service provider sites. Accordingly, in this example, the trust establishment protocol allows users to: authenticate at an affiliate site and seamlessly navigate to a protected portal site; authenticate at a portal site and seamlessly navigate to a protected affiliate site; and/or authenticate at a portal site and seamlessly obtain trusted data from a protected affiliate site.

In a practical deployment, the data communication (trust establishment) protocol can be realized as one or more computer programs embodied on a computer-readable medium, e.g., a hard drive or other magnetic storage device, a CD-ROM, a floppy disk, a ROM chip, a firmware device, or the like. In accordance with conventional computer science techniques, the computer programs include computer-executable instructions for carrying out the various processing steps described herein. In the example system described below, each of the communicating web sites (e.g., the portal site and the affiliate site) is associated with one or more computer programs configured to carry out such processing steps. For example, the portal site may be maintained on one server computer (or a first plurality of servers) that executes one or more programs containing instructions for carrying out the techniques of the present invention, and the affiliate site may be maintained on a second server computer (or a second plurality of servers) that executes one or more programs containing instructions for carrying out the techniques of the present invention. In an alternative arrangement, the portal and affiliate sites can both be maintained on a single server computer (or a common collection of servers), and the functionality of the two sites can be logically separated.

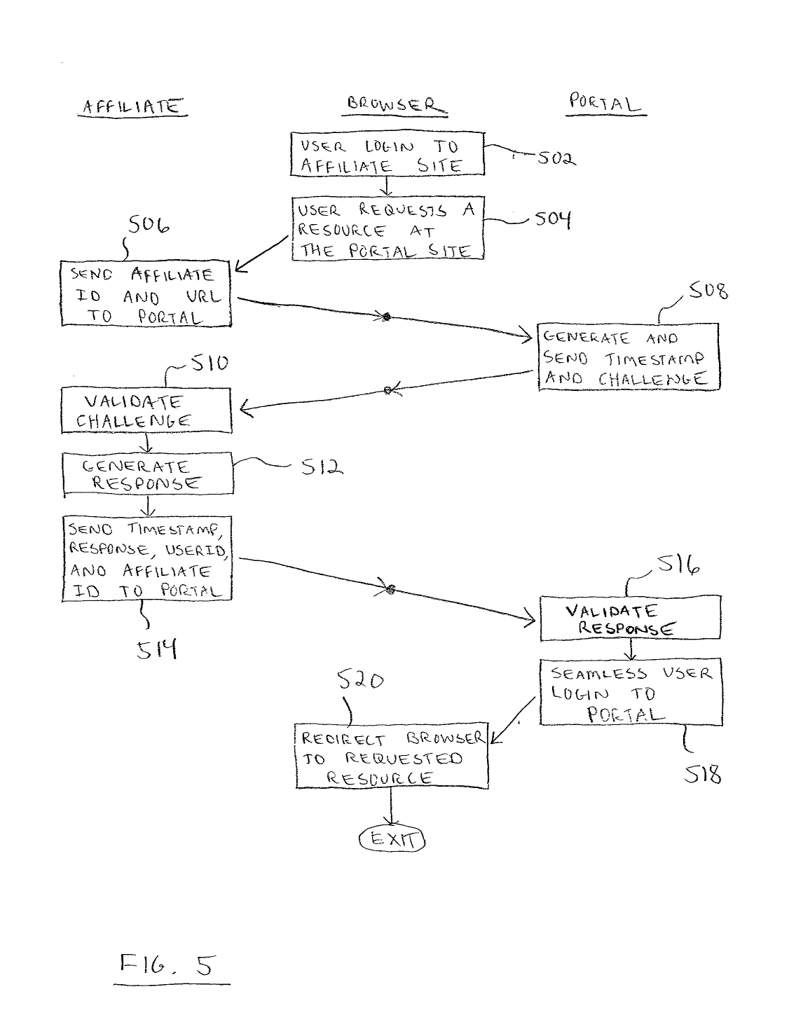

FIG. 5 is a flow diagram representing an example single sign-on protocol according to the present invention. In this example, an end user has access to a portal web site and an affiliate web site via a web browser installed on the end user PC. Referring to FIG. 1, the sender component 102 may be associated with the affiliate site, and the receiver component 104 may be associated with the portal site. In a practical implementation, the web browser can be a conventional off-the-shelf web browser product such as Microsoft's Internet Explorer. In accordance with known techniques, the web browser is capable of redirecting data (e.g., HTTP traffic) between the affiliate site and the portal site. Consequently, the affiliate site and the portal site need not establish a direct communication between each other; they can communicate with each other via the user's web browser.

The example single sign-on process assumes that a user has already performed a login at the affiliate site (task 502). In other words, the user is authenticated at the affiliate site. Eventually, the user requests a resource located at the portal site (task 504). In practice, task 504 may be performed in response to the selection of a suitable link displayed on a page of the affiliate site. The link should have an HTTP reference to the sender component 102 on the affiliate site. The link may also identify the destination page or requested resource at the portal site. A suitable link can be of the following form:

http://www.affiliate.com/cgi/affiliate.exe?res=http://www.portal.com/index.html

By clicking on this URL, the user is sent to the sender component 102 on the affiliate site, which initiates a handshake with the portal site. The requested resource on the portal site is contained in the query string; this final destination page can be designated during installation or setup of the affiliate site.

In response to the request, the affiliate site sends its site ID and its URL to the portal site (task 506). Task 506 corresponds to task 402 in FIG. 4A. In practice, the affiliate site redirects the user's web browser to facilitate communication with the portal site. In this regard, the affiliate site may utilize the following URL:

Location:

http://www.portal.com/servlet/ProductName?res=http://www portal.com/index.html&siteid=IMG&seqno=1&myurl=http://www.affiliate.com/cgi/affiliate.exe&userid=jackn

The sample URL (and any of the example URLs described herein) is merely a semantic expression of the data that is passed. In reality, the URL may be transformed, encoded, shortened, or otherwise modified according to any specified criteria. The query string includes the following data:

“res”—the requested resource on the portal site that the user wants to access;

“siteid”—the site ID of the affiliate site;

“seqno”—the sequence number of the current step in the handshake;

“myurl”—the URL of the sender component on the affiliate site; and

“userid”—the username of the end user.

Notably, although the username “jackn” is the data element intended to be transmitted in a trusted manner, its inclusion in the above URL merely serves a housekeeping purpose—the portal site extracts the username and makes a log entry; at this point, the username plays no role in the sign-on process.

Once the user is redirected to the portal site, the receiver component 104 at the portal site performs various processing tasks and eventually redirects the web browser back to the sender component 102 at the affiliate site. The portal site generates a timestamp and a challenge and sends the timestamp and the challenge back to the affiliate site (task 508). Task 508 corresponds to tasks 404, 406, 408, 410, and 412 described above in connection with FIG. 4. The redirection to the affiliate site may be accomplished with the following example URL:

http://www.affiliate.com/cgi/affiliate.exe ?timestamp=968782825569&seqno=2&challenge=74ebae9a628a2e4303d2bb2b897d107477b3b41e&res=http://www.portal.com/index.html

Notably, in this example the timestamp is represented by a 12-digit string, and the challenge is represented by a 40-character alphanumeric string (resulting from the application of the SHA-1 hashing operation). The field “seqno=2” indicates that the handshake process has proceeded to the second generalized step. The affiliate site reads the query string and stores the data for use in the next step.

The affiliate site validates the challenge (task 510), generates a suitable response (task 512), and sends the timestamp, response, userid, and the affiliate site ID to the portal site (task 514). Task 510 may correspond to tasks 414, 416, and 420, task 512 corresponds to tasks 422 and 424, and task 514 corresponds to task 426 (see FIG. 4). The characteristics and format of the response will be dictated by the validation routine. For example, if the challenge is validated, then the response is generated as described above in connection with FIG. 4. However, if the challenge confirmation does not match the received challenge, then the affiliate site may generate a random or invalid response (for example, the affiliate site may perform the SHA-1 hashing operation on a random string). Such an error-driven response can serve as an error message to the portal site.

In connection with task 514, the affiliate site redirects the user web browser with the following example URL:

Location:

http://www.portal.com/servlet/ProductName?res=http://www.portal.com/index.html&siteid=IMG&seqno=3&timestamp=968782825569&response=323b15096462e432b10f3270db947cde7efefd06&userid=jackn

In this example, the response is a 40-character alphanumeric string generated by the SHA-1 hashing algorithm. The “userid=jackn” field represents the data element being transmitted from the affiliate site to the portal site.

After receiving this information, the portal site validates the response (task 516) in the manner described above in connection with tasks 428, 430, 432, and 434. Assuming that the response is properly validated, then the portal site can accept and trust the received userid and conduct a seamless user login (task 518). Ultimately, the user's web browser is redirected to the requested resource at the portal site (task 520). In this example, the web browser would be directed to the resource http://www.portal.com/index.html. In this manner, the user can easily navigate and access protected resources on the portal site without having to separately login to the portal site—the user need only initially login to the affiliate site (see task 502).

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A data communication method comprising:
sending an ID from a first component to a second component, said ID identifying said first component;
sending a challenge from said second component to said first component, said challenge being based upon said ID;
sending a response to said challenge, and a data element, from said first component to said second component if said first component validates said challenge, said response being based upon said data element; and
accepting said data element at said second component if said second component validates said response.

2. A method according to claim 1, further comprising:
said second component retrieving a shared key corresponding to said ID; and
said second component generating said challenge based upon said shared key.

3. A method according to claim 2, further comprising said second component creating a timestamp, wherein generating said challenge comprises said second component generating said challenge based upon said shared key and said timestamp.

4. A method according to claim 3, wherein generating said challenge comprises:
forming a string based upon said shared key and said timestamp; and
performing a one-way hashing operation on said string.

5. A method according to claim 3, further comprising sending said timestamp from said second component to said first component.

6. A method according to claim 1, further comprising said first component performing a validation routine on said challenge.

7. A method according to claim 1, further comprising:
said first component retrieving a shared key corresponding to said ID; and
said first component generating said response based upon said shared key and said data element.

8. A method according to claim 7, wherein generating said response comprises said first component generating said response based upon said shared key, said data element, and said challenge.

9. A method according to claim 8, wherein generating said response comprises:
forming a string based upon said shared key, said data element, and said challenge; and
performing a one-way hashing operation on said string.

10. A method according to claim 1, further comprising said second component performing a validation routine on said response.

11. A data communication method comprising:
conducting a challenge-response protocol to establish trust between a first component and a second component;
sending a data element from said first component to said second component during said challenge-response protocol; and
verifying integrity of said data element as received by said second component.

12. A data communication method according to claim 11, wherein conducting said challenge-response protocol comprises:
said second component retrieving a secret key shared between said first component and said second component; and
said second component generating a challenge based upon said secret key.

13. A data communication method according to claim 12, wherein conducting said challenge-response protocol comprises:
sending said challenge from said second component to said first component;
said first component retrieving said secret key; and
said first component generating a response to said challenge based upon said secret key and said data element.

14. A method according to claim 13, wherein generating said response comprises said second component generating said response based upon said shared key, said data element, and said challenge.

15. A method according to claim 14, further comprising:
sending said response from said first component to said second component;
said second component performing a validation routine on said response; and
accepting said data element at said second component if said second component validates said response.

16. A data communication method comprising:
sending an ID from a first component to a second component, said ID identifying said first component;
receiving a challenge from said second component, said challenge being based upon said ID;
generating a response to said challenge, said response being based upon a data element; and
sending said response, and said data element, to said second component.

17. A method according to claim 16, further comprising performing a validation routine on said challenge.

18. A method according to claim 16, wherein generating said response comprises said first component generating said response based upon said data element and said challenge.

19. A method according to claim 18, wherein generating said response comprises:
forming a string based upon said data element and said challenge; and
performing a one-way hashing operation on said string.

20. A computer program for establishing trust between a first processing component and a second processing component, said computer program being embodied on a computer-readable medium, said computer program having computer-executable instructions for carrying out a method comprising:
sending an ID from a first component to a second component, said ID identifying said first component;
receiving a challenge from said second component, said challenge being based upon said ID;
generating a response to said challenge, said response being based upon a data element; and
sending said response, and said data element, to said second component.

21. An apparatus for establishing trusted data communication with a processing component, said apparatus comprising:
at least one data communication element configured to establish a communication session with said processing component, send data to said processing component, and receive data from said processing component; and
at least one processor configured to carry out a method comprising:
sending an ID from a first component to a second component, said ID identifying said first component;
receiving a challenge from said second component, said challenge being based upon said ID;
generating a response to said challenge, said response being based upon a data element; and
sending said response, and said data element, to said second component.

22. A data communication method comprising:
retrieving a secret key shared between a first component and a second component;
generating a challenge based upon said secret key;
sending said challenge to said first component;
receiving a data element from said first component;
receiving a response to said challenge from said first component, said response being based upon said data element; and
said second component accepting said data element if said second component validates said response.

23. A method according to claim 22, further comprising performing a validation routine on said response.

24. A method according to claim 23, wherein said validation routine comprises:
generating a response confirmation based upon said data element received by said second component; and
comparing said response confirmation to said response received by said second component.

25. A method according to claim 22, further comprising receiving an ID that identifies said first component, said secret key corresponding to said ID.

26. A method according to claim 22, wherein generating said challenge comprises:
forming a string based upon said secret key; and
performing a one-way hashing operation on said string.

27. A computer program for establishing trust between a first processing component and a second processing component, said computer program being embodied on a computer-readable medium, said computer program having computer-executable instructions for carrying out a method comprising:
retrieving a secret key shared between a first component and a second component;
generating a challenge based upon said secret key;
sending said challenge to said first component;
receiving a data element from said first component;
receiving a response to said challenge from said first component, said response being based upon said data element; and
said second component accepting said data element if said second component validates said response.

28. An apparatus for establishing trusted data communication with a processing component, said apparatus comprising:
at least one data communication element configured to establish a communication session with said processing component, send data to said processing component, and receive data from said processing component; and
at least one processor configured to carry out a method comprising:
retrieving a secret key shared between a first component and a second component;
generating a challenge based upon said secret key;
sending said challenge to said first component;
receiving a data element from said first component;
receiving a response to said challenge from said first component, said response being based upon said data element; and
said second component accepting said data element if said second component validates said response.
